(19) United States
(12) Patent Application Publication
(10) Pub. No.: US 2012/0089708 A1
(43) Pub. Date: Apr. 12, 2012

(54) IDENTIFIER MANAGEMENT SERVER, APPLICATION SERVICE PLATFORM, METHOD AND SYSTEM FOR RECOGNIZING DEVICE USING IDENTIFIER OF SENSOR NODE

(75) Inventors: Mal Hee KIM, Daejeon (KR); Jae Gak Hwang, Daejeon (KR)

(73) Assignee: Electronics and Telecommunications Research Institute, Daejeon (KR)

(21) Appl. No.: 13/242,747

(22) Filed: Sep. 23, 2011

(30) Foreign Application Priority Data
Oct. 6, 2010 (KR) 10-2010-0097186

(51) Int. Cl. G06F 15/173; G06F 15/177

(52) U.S. Cl. 709/220; 709/223

(57) ABSTRACT

Provided is a method that may provide an application extensibility by providing an open operation structure where an application service platform provides a service in interoperation with a sensor node or a sensor network including n sensor nodes. A device recognition system using an identifier of a sensor node may include: an identifier management server to obtain the identifier of the sensor node, and to provide address information regarding metadata and interface configuration software that are associated with the obtained identifier; and an application service platform to download the metadata and the interface configuration software using the provided address information, and to communicate with the sensor node based on the downloaded metadata and interface configuration software.

### CROSS-REFERENCE TO RELATED APPLICATION

This application claims the benefit of Korean Patent Application No. 10-2010-0097186, filed on Oct. 6, 2010, in the Korean Intellectual Property Office, the disclosure of which is incorporated herein by reference.

### BACKGROUND

1. Field of the Invention

Embodiments of the present invention relate to a controlling method for enabling a communication between a sensor node or a sensor network and an application service platform.

2. Description of the Related Art

For a communication between a sensor node or a sensor network, for example, a gateway and an application service platform, the application service platform may need to be aware of metadata and interface configuration software that are associated with the sensor node. For the above purpose, two schemes have been employed.

According to one scheme, as in an Institute of Electrical and Electronics Engineers (IEEE) 1451, a Global Sensor Network (GSN), and a Sensor Web Enablement (SWE), the sensor node may transmit a self-description while connection is ongoing and thereby, the application service platform may perform communication based on corresponding information. According to another scheme, as in a Ubiquitous Sensor Network (USN) middleware platform developed by Electronics and Telecommunications Research Institute (ETRI), metadata and interface configuration software may be pre-registered in a data repository based on a sensor network unit. When a registered sensor network requests a connection, connection establishment and query processing may be enabled based on the stored metadata and interface configuration software.

The sensor node and the sensor network may be different from each other in aspects of a communication interface, a providing data parameter, a processing capability, and the like. To use different sensor resources, for example, the sensor node and the sensor network, the application service platform may need to be aware of information regarding an operation parameter, a supporting sensor type, a unit of a measurement value, a processing capability, and the like. In general, the application service platform may obtain information associated with the sensor node (hereinafter, will be described as a concept including the sensor network) using two schemes: one scheme of pre-storing, by the application service platform, information of a sensor node to be used in a data repository to be used and then using the stored information, and another scheme of spontaneously transferring, by the sensor node, metadata to the application service platform when the sensor node is connected to the application service platform.

In the first scheme, information of the sensor node to be used may need to be pre-registered for each application service platform. Accordingly, in the case of an interoperation with a sensor node being serviced in a different domain or a new sensor node, the sensor node is not registered and thus, the interoperation may be impossible. However, in the case of an interoperation with a pre-registered sensor node, it is possible to stably provide an information protection service such as authentication, encoding/decoding, and the like.

FIG. 1 illustrates an example of establishing a communication between an application service platform and a sensor node according to a conventional pre-registration method that is one of conventional methods.

Referring to FIG. 1, when a sensor node manager pre-registers information associated with the sensor node in a data repository in operation 1, the sensor node and the application service platform may construct a communication interface between the sensor node and the application service platform by performing operations 2 through 5. In this instance, an interface used for operations 2 through 5 is predefined and all the sensor nodes may perform communication through the corresponding interface.

The latter scheme corresponds to a scheme of registering, by the sensor node, metadata of the sensor node and using the registered metadata for interoperation with the application service platform. Accordingly, the interoperation may be very flexible with respect to a sensor node moving between domains and various types of sensor nodes.

FIG. 2 illustrates an example of establishing a communication between an application service platform and a sensor node according to a conventional self-registration method that is one of conventional methods.

Referring to FIG. 2, in operation 1, the sensor node may spontaneously request a connection to the application service platform by registering metadata of the sensor node to the application service platform. In this case, in operation 2, the application service platform may establish a communication with the sensor node using the metadata.

However, since the sensor node itself registers the metadata, it may be an issue to protect the application service platform from a malicious sensor node. Also, all the sensor nodes may need to transmit self-description.

### SUMMARY

An aspect of the present invention provides a device recognition method and system using an identifier of a sensor node that may provide an application extensibility by providing an open operation structure where an application service platform provides a service in interoperation with a sensor node or a sensor network including n sensor nodes.

An aspect of the present invention also provides an identifier management server that may provide a reliable inter-communication channel so that an application service platform may download interface configuration software for communication with a sensor node associated with metadata and may access the sensor node when obtaining the metadata.

An aspect of the present invention also provides an application service platform that may guarantee an extensibility with respect to an interface change by enabling an application service platform to dynamically download interface configuration software and may effectively use a suitable interface and thereby may expect the efficiency with respect to an operation of the application service platform.

According to an aspect of the present invention, there is provided a device recognition system using an identifier of a sensor node, including: an identifier management server to obtain the identifier of the sensor node, and to provide address information regarding metadata and interface configuration software that are associated with the obtained identifier; and an application service platform to download the metadata and the interface configuration software using the provided address information, and to communicate with the sensor node based on the downloaded metadata and interface configuration software.

The identifier management server may obtain a network identifier of a sensor network including at least n sensor nodes where n denotes a natural number. The application service platform may communicate with the sensor network based on network metadata and network interface software that are associated with the sensor network.

The device recognition system may further include a data repository to store metadata and interface configuration software that are associated with an identifier of each sensor node, to provide, to the identifier management server, address information regarding the metadata and the interface configuration software, and to provide, to the application service platform, the metadata and the interface configuration software.

The data repository may include a metadata repository unit to store the metadata associated with the identifier of each sensor node; and a software repository unit to store the interface configuration software associated with the identifier of each sensor node.

The sensor node may transmit the identifier of the sensor node to the application service platform in response to a request of the application service platform or spontaneously.

The metadata may include at least one of a setup parameter, an operation parameter, a sensing type, a measurement unit, and a processing capability with respect to the sensor node.

According to another aspect of the present invention, there is provided an identifier management, including: a database to store address information regarding metadata and interface configuration software that are associated with an identifier of each sensor node; an obtainment unit to obtain the identifier of each sensor node from an application service platform; and a providing unit to identify, from the database, address information regarding metadata and interface configuration software that are associated with the obtained identifier, and to provide the identified address information to the application service platform.

According to still another aspect of the present invention, there is provided an application service platform, including: a downloader to download, from a data repository, metadata and interface configuration software that are associated with a sensor node; and an application unit to provide a service to the sensor node using the metadata and the interface configuration software.

The application service platform may further include an operation unit to operate the downloaded metadata and interface configuration software, and to transmit, to an identifier management server, an identifier of the sensor node that is obtained from the sensor node.

According to yet another aspect of the present invention, there is provided a device recognition method using an identifier of a sensor node, the method including: obtaining, by an identifier management server, the identifier of the sensor node from an application service platform; providing, by the identifier management server to the application service platform, address information regarding metadata and interface configuration software that are associated with the obtained identifier; downloading, by the application service platform, the metadata and the interface configuration software using the provided address information; and communicating, by the application service platform, with the sensor node based on the downloaded metadata and interface configuration software.

According to a further another aspect of the present invention, there is provided a device recognition method using an identifier of a sensor node, the method including: storing, in a database, address information regarding metadata and interface configuration software that are associated with an identifier of each sensor node; obtaining the identifier of each sensor node from an application service platform; identifying, from the database, address information regarding metadata and the interface configuration software that are associated with the obtained identifier; and providing the identified address information to the application service platform.

### EFFECT

According to embodiments of the present invention, it is possible to provide an application extensibility by providing an open operation structure where an application service platform provides a service in interoperation with a sensor node or a sensor network including n sensor nodes.

Also, according to embodiments of the present invention, it is possible to provide a reliable inter-communication channel so that an application service platform may download interface configuration software for communication with a sensor node associated with metadata and may access the sensor node when obtaining the metadata.

Also, according to embodiments of the present invention, it is possible to guarantee an extensibility with respect to an interface change by enabling an application service platform to dynamically download interface configuration software, and to effectively use a suitable interface and to thereby expect the efficiency with respect to an operation of the application service platform.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of establishing a communication between an application service platform and a sensor node according to a conventional pre-registration method;

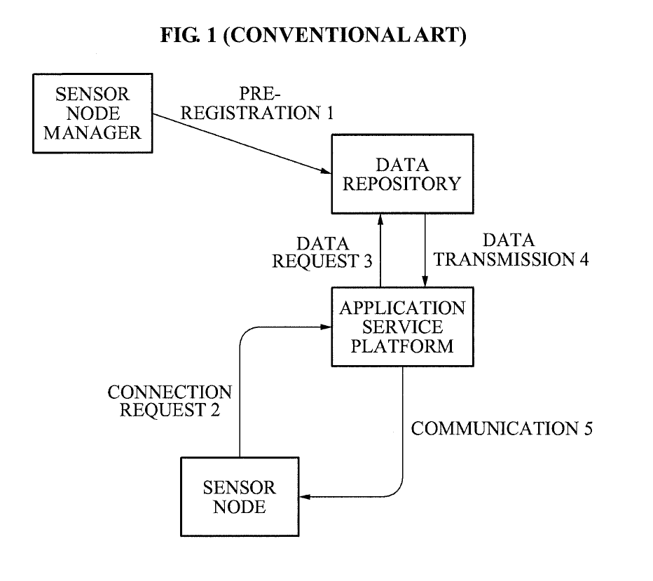

FIG. 2 is a diagram illustrating an example of establishing a communication between an application service platform and a sensor node according to a conventional self-registration method;

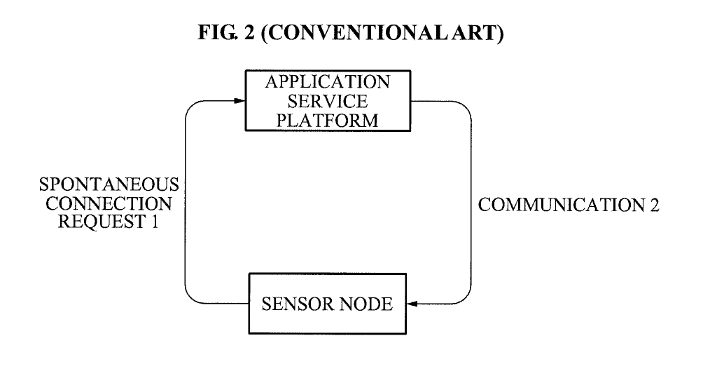

FIG. 3 is a block diagram illustrating a configuration of a device recognition system using an identifier of a sensor node according to an embodiment of the present invention;

FIG. 4 is a block diagram illustrating a configuration of an identifier management server according to an embodiment of the present invention;

FIG. 5 is a block diagram illustrating a configuration of an application service platform according to an embodiment of the present invention; and

FIG. 6 is a flowchart illustrating a device recognition method using an identifier of a sensor node according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

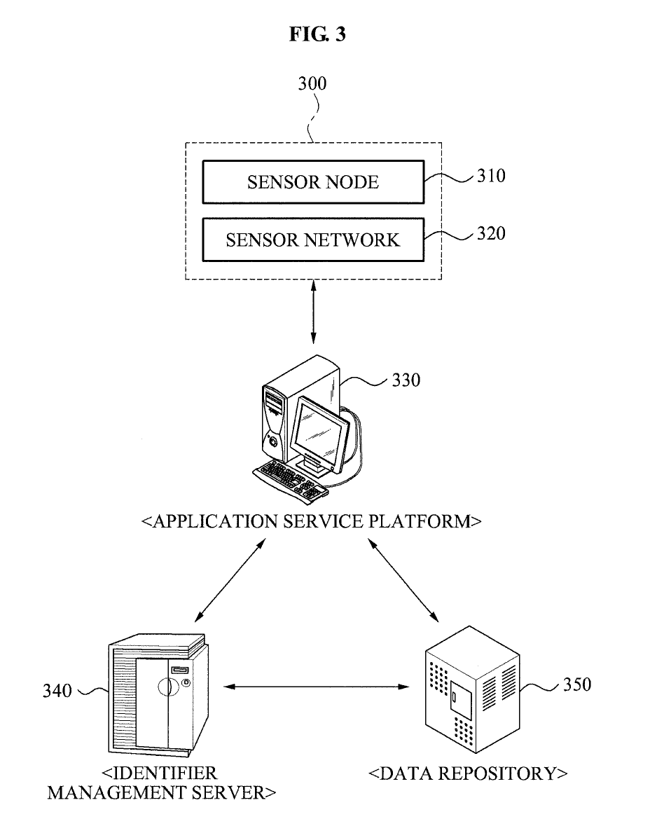

FIG. 3 is a block diagram illustrating a configuration of a device recognition system 300 using an identifier of a sensor node 310 according to an embodiment of the present invention.

Referring to FIG. 3, the device recognition system 300 using the identifier of the sensor node 310 may include an application service platform 330, an identifier management server 340, and a data repository 350.

The sensor node 310 desiring to communicate with the application service platform 330 may provide the identifier of the sensor node 310 to the application service platform 330. The identifier of the sensor node 310 may be provided through a response form according to a request of the application service platform 330, or may be arbitrarily provided by the sensor node 310. In this instance, an interface for providing an identifier may need to be configured by both the sensor node 310 and the application service platform 330.

The sensor node 310 denotes a small device, for example, a Radio Frequency Identification (RFID) reader, having a sensing and communication function for measuring a physical phenomenon.

A sensor network 320 may include at least n sensor nodes 310. Here, n denotes a natural number. Like the sensor node 310, the sensor network 320 may provide a network identifier of the sensor network 320 to the application service platform 330. Accordingly, the sensor network 320 may be one of entities performing the present invention, described hereinafter, which is the same as the sensor node 310. Hereinafter, for clarity, descriptions will be made based on only the sensor node 310. However, the present invention may also be applicable to the sensor network 320.

The application service platform 330 may transmit the received identifier to the identifier management server 340 to obtain address information associated with the identifier.

The identifier management server 340, which is also referred to as an identifier management server, may maintain address information regarding metadata and interface configuration software that are associated with a corresponding identifier or a network identifier based on the identifier for identifying each sensor node 310 and the network identifier for identifying the sensor network 320. The identifier management server 340 may also maintain address information of the data repository 350 that stores the metadata and the interface configuration software. The identifier management server 340 may be globally operated all over the world without collision, and may have a hierarchical structure based on an identifier system or a service classification with respect to the sensor node 310 or the sensor network 320.

The identifier management server 340 may obtain the identifier of the sensor node 310 from the application service platform 330, and may provide, to the application service platform 330, address information regarding the metadata and the interface configuration software that are associated with the obtained identifier.

The application service platform 330 may access the data repository 350 using the provided address information and may download, from the data repository 350, the metadata 310 and the interface configuration software that are associated with the sensor node 310. Here, the metadata may include at least one of a setup parameter, an operation parameter, a sensing type, a measurement unit, and a processing capability with respect to the sensor node 310.

The data repository 350 may maintain the metadata and the interface configuration software that are associated with the sensor node 310, and may register, in the identifier management server 340, address information regarding the metadata and the interface configuration software. The data repository 350 may be separately configured as a metadata repository unit to store a parameter for a setup and an operation of the sensor node 310, and a software repository unit to store the interface configuration software associated with the identifier of the sensor node 310. The single data repository 350 may also provide two functions.

When the data repository 350 is classified into two repository units and thereby operated, address information used to access the metadata repository unit and the software repository unit may be registered to the identifier management server 340. For example the metadata repository unit may provide address information of the software repository unit, or may store the address information of the software repository unit to be lined thereto.

The data repository 350 may provide, to the application service platform 330, the metadata and the interface configuration software that are associated with the sensor node 310.

The application service platform 330 may authenticate the sensor node 310 and then exchange data and an instruction with the sensor node 310. The application service platform 330 may need to have an operation service structure for dynamic integration of the dynamically downloaded interface configuration software, and for communication with the sensor node 310 using the integrated interface configuration software.

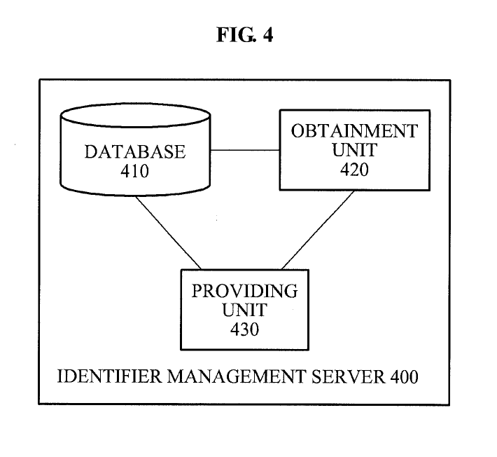

FIG. 4 is a block diagram illustrating a configuration of an identifier management server 400 according to an embodiment of the present invention.

Referring to FIG. 4, the identifier management server 400 may include a database 410, an obtainment unit 420, and a providing unit 430.

The database 410 may store address information regarding metadata and interface configuration software that are associated with an identifier of each sensor node. The identifier management server 400 may receive, from a data repository, a registration of the address information regarding the metadata and the interface configuration software that are associated with the identifier of each sensor node, and may store the address information in the database 410.

The obtainment unit 420 may obtain the identifier of the sensor node from an application service platform. The identifier of the sensor node may be obtained spontaneously by the sensor node or from the application service platform in response to the application service platform. That is, the obtainment unit 420 may obtain the identifier of the sensor node using the application service platform.

The providing unit 430 may identify, from the database 410, address information regarding metadata and interface configuration software that are associated with the identified identifier.

Depending on embodiments, the identifier management server 400 may have a hierarchical structure according to an identifier system such as a Domain Name Server (DNS) operation, and may enhance an access rate by operating a cash server in operation. The identifier management server 400 may use the sensor node and the identifier as input parameters and may use the address information as an output parameter.

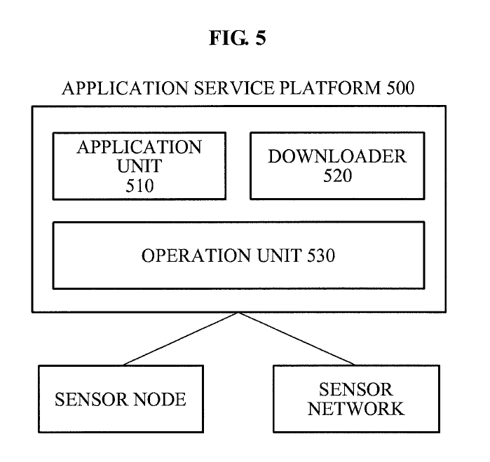

FIG. 5 is a block diagram illustrating a configuration of an application service platform 500 according to an embodiment of the present invention.

Referring to FIG. 5, the application service platform 500 may include an application unit 510, a downloader 520, and an operation unit 530.

The operation unit 530 may obtain an identifier of a sensor node from the sensor node, and may transmit the obtained identifier to an identifier management server. Next, the operation unit 530 may receive, from the identifier management server, address information regarding metadata and interface configuration software that are associated with the transmitted identifier.

The downloader 520 may access a data repository using the received address information, and may download, from the accessed data repository, the metadata and the interface configuration software that are associated with the sensor node.

The application unit 510 may provide a service to the sensor node using the downloaded metadata and interface configuration software.

The operation unit 530 may operate the downloaded metadata and interface configuration software.

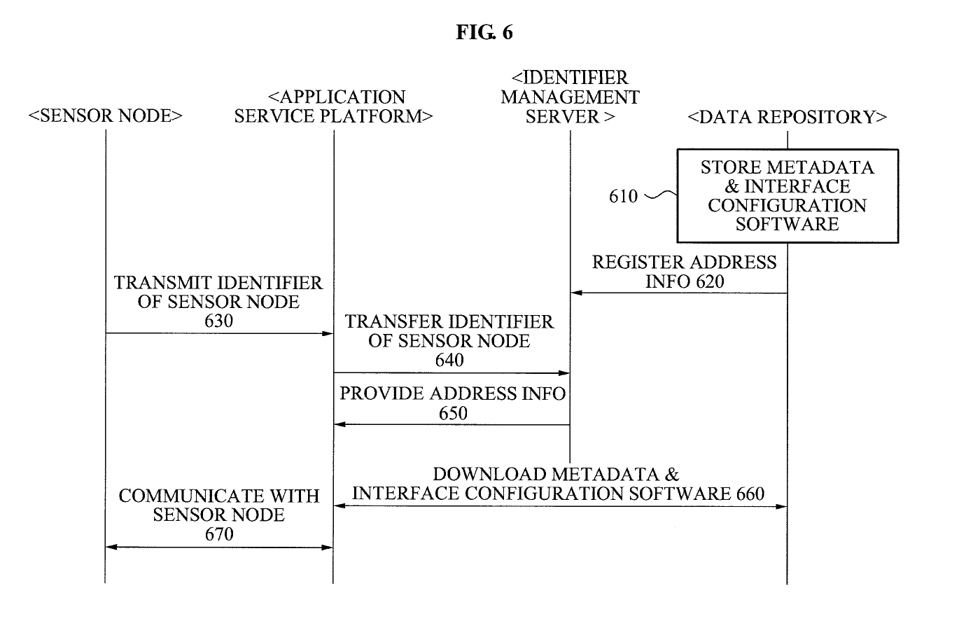

FIG. 6 is a flowchart illustrating a device recognition method using an identifier of a sensor node according to an embodiment of the present invention.

Referring to FIG. 6, in operation 610, a data repository may store metadata and interface configuration software that are associated with an identifier of each sensor node. The metadata may include at least one of a setup parameter, an operating parameter, a sensing type, a measurement unit, and a processing capability with respect to each sensor node. The interface configuration software may include an interface for each sensor node or software for configuring the interface.

In operation 620, the data repository may register, in an identifier management server, address information regarding the metadata and the interface configuration software. Accordingly, the identifier management server may store, in a database, the address information regarding the metadata and the interface configuration software.

In operation 630, the sensor node may transmit the identifier of the sensor node to the application service platform. In this instance, the sensor node may transmit the identifier of the sensor node to the application service platform in response to a request of the application service platform or spontaneously.

In operation 640, the application service platform may transfer the transmitted identifier of the sensor node to the identifier management server.

In operation 650, the identifier management server may identify, from the database, address information regarding metadata and interface configuration software that are associated with the transferred identifier, and may provide the identified address information to the application service platform.

In operation 660, the application service platform may access the data repository using the address information, and may download, from the data repository, metadata and interface configuration software corresponding to the identifier of the sensor node.

In operation 670, the application service platform may communicate with the sensor node using the downloaded metadata and interface configuration software.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A device recognition system using an identifier of a sensor node, comprising:
an identifier management server to obtain the identifier of the sensor node, and to provide address information regarding metadata and interface configuration software that are associated with the obtained identifier; and
an application service platform to download the metadata and the interface configuration software using the provided address information, and to communicate with the sensor node based on the downloaded metadata and interface configuration software.

2. The device recognition system of claim 1, wherein:
the identifier management server obtains a network identifier of a sensor network comprising at least n sensor nodes where n denotes a natural number, and
the application service platform communicates with the sensor network based on network metadata and network interface software that are associated with the sensor network.

3. The device recognition system of claim 1, further comprising:
a data repository to store metadata and interface configuration software that are associated with an identifier of each sensor node, to provide, to the identifier management server, address information regarding the metadata and the interface configuration software, and to provide, to the application service platform, the metadata and the interface configuration software.

4. The device recognition system of claim 3, wherein the data repository comprises:
a metadata repository unit to store the metadata associated with the identifier of each sensor node; and
a software repository unit to store the interface configuration software associated with the identifier of each sensor node.

5. The device recognition system of claim 1, wherein the sensor node transmits the identifier of the sensor node to the application service platform in response to a request of the application service platform or spontaneously.

6. The device recognition system of claim 1, wherein the metadata comprises at least one of a setup parameter, an operation parameter, a sensing type, a measurement unit, and a processing capability with respect to the sensor node.

7. An identifier management server, comprising:
a database to store address information regarding metadata and interface configuration software that are associated with an identifier of each sensor node;
an obtainment unit to obtain the identifier of each sensor node from an application service platform; and
a providing unit to identify, from the database, address information regarding metadata and interface configuration software that are associated with the obtained identifier, and to provide the identified address information to the application service platform.

8. An application service platform, comprising:
a downloader to download, from a data repository, metadata and interface configuration software that are associated with a sensor node; and
an application unit to provide a service to the sensor node using the metadata and the interface configuration software.

9. The application service platform of claim 8, further comprising:
an operation unit to operate the downloaded metadata and interface configuration software, and to transmit, to an identifier management server, an identifier of the sensor node that is obtained from the sensor node.

10. A device recognition method using an identifier of a sensor node, the method comprising:
obtaining, by an identifier management server, the identifier of the sensor node from an application service platform;
providing, by the identifier management server to the application service platform, address information regarding metadata and interface configuration software that are associated with the obtained identifier;
downloading, by the application service platform, the metadata and the interface configuration software using the provided address information; and
communicating, by the application service platform, with the sensor node based on the downloaded metadata and interface configuration software.

11. The method of claim 10, further comprising:
obtaining, by the identifier management server, a network identifier of a sensor network comprising at least n sensor nodes where n denotes a natural number.

12. The method of claim 10, further comprising:
communicating, by the application service platform, with the sensor network based on network metadata and network configuration software that are associated with the sensor network.

13. The method of claim 10, further comprising:
storing, by a data repository, metadata and interface configuration software that are associated with an identifier of each sensor node;
providing, by the data repository to the identifier management server, address information regarding the metadata and the interface configuration software; and
providing, by the data repository to the application service platform, the metadata and the interface configuration software.

14. The method of claim 10, further comprising:
transmitting, by the sensor node, the identifier of the sensor node to the application service platform in response to a request of the application service platform or spontaneously.

15. The method of claim 10, wherein the metadata comprises at least one of a setup parameter, an operation parameter, a sensing type, a measurement unit, and a processing capability with respect to the sensor node.

16. A device recognition method using an identifier of a sensor node, the method comprising:
storing, in a database, address information regarding metadata and interface configuration software that are associated with an identifier of each sensor node;
obtaining the identifier of each sensor node from an application service platform;
identifying, from the database, address information regarding metadata and the interface configuration software that are associated with the obtained identifier; and
providing the identified address information to the application service platform.

17. A device recognition method using an identifier of a sensor node, the method comprising:
downloading, from a data repository, metadata and interface configuration software that are associated with the sensor node; and
providing a service to the sensor node using the metadata and the interface configuration software.

18. The method of claim 17, further comprising:
transmitting the obtained identifier of the sensor node to an identifier management server; and
operating the downloaded metadata and interface configuration software.
